(19) United States
(12) Patent Application Publication
(10) Pub. No.: US 2017/0294240 A1
(43) Pub. Date: Oct. 12, 2017

(54) SYSTEMS AND METHODS FOR THERMAL INTERCONNECT

(71) Applicant: Elysium Industries Limited, Vancouver (CA)

(72) Inventors: Emilio Baglietto, Boston, MA (US); Andrew McCall Dodson, Malden, MA (US); William Wangard, Boston, MA (US); Mark Levesque, Scarborough, ME (US)

(21) Appl. No.: 15/357,875

(22) Filed: Nov. 21, 2016

Related U.S. Application Data
(60) Provisional application No. 62/258,041, filed on Nov. 20, 2015.

(51) Int. Cl. G21C 1/22; G21C 3/54

(52) U.S. Cl. CPC G21C 1/22; G21C 3/54; G21Y 2004/30

(57) ABSTRACT

A power system can connect to a nuclear reactor through a standardized connection. The standardized connection is configured so that the nuclear reactor may be designed independently of the power system. Systems include a reactor core in fluid communication with a heat exchanger. A fluid loop passes through the heat exchanger. The system includes an output and inlet manifolds at the ends of the fluid loop, terminating in ports that include a standardized connection mechanism. When the secondary system is coupled to the connection mechanism, the fluid loop and the secondary system define a distal loop. A working fluid can then flow through the distal loop and transfer heat from the reactor core to the secondary system.

### RELATED APPLICATION

This application claims the benefit of and is related priority to U.S. provisional patent application Ser. No. 62/258,041, filed Nov. 20, 2015, the content of which is incorporated by reference herein by reference in its entirety.

### TECHNOLOGICAL FIELD

This disclosure relates to the field of thermal power as provided, for example, by a molten salt reactor.

### BACKGROUND

Nuclear power plants have difficulty competing economically due, in part, to an inability to adapt plant function to shifting demand. Existing nuclear power plants typically include a nuclear reactor core coupled to a power conversion system. Energy from the reactor core is transferred to the power conversion system to be converted via a steam turbine to electricity. Unfortunately, highly variable loads of most markets are not inherently matched to the steady baseline power of a nuclear power plant. Additionally, existing water cooled reactors operate at such high pressures and low temperatures that they are only suited to Rankine cycle steam generation. Moreover, the high pressures throughout both subsystems and the significant hazards associated with failure anywhere, require unified safety systems. For these reasons, nuclear power plants are seen as a single monolithic entity in which the reactor core and power generation system co-operate.

Under this paradigm, nuclear power plants are currently licensed by the government and designed as combined nuclear generator and power conversion plants. Some advanced reactor concepts considered to be “Generation IV reactors” operate at low pressure and high temperature. However, there are significant costs in building, licensing, and operating reactors, especially when seeking to use newer, advanced reactor concepts.

### SUMMARY

The systems and components described throughout this disclosure provide a standardized thermal connection that can be used to connect a power conversion system to a nuclear thermal generator plant (NTGP). The connection is standardized so that NTGP and the power conversion system may be designed and built separately, even by separate parties. Thus, a nuclear reactor can be built independently to be operated as an NTGP. A secondary system such as a power conversion system may be built and connected to the NTGP by another party, or at a later date, for example. A single design for the NTGP may be put to different uses by connection to different secondary systems. For example, a power conversion system may be connected that uses the thermal energy to create steam that drives a turbine to generate electricity. Additionally or alternatively, the secondary system may be used for water desalination, industrial heating, or some other purpose.

Interconnectivity through the standardized connection mechanism may be facilitated in particular where the NTGP is a molten salt reactor. Since molten salt reactors operate at low pressure, relative to light water reactors, there is freedom in the design to build in valves and fittings according to a defined standard to allow third-parties to build a connectable secondary system. In such a reactor, thermal energy is transferred from the NTGP to the secondary system using a working fluid (e.g., a coolant salt) that flows from a primary heat exchanger close to the reactor core out to the secondary system. At the secondary system, the heat is harvested for a useful purpose. The then relatively cooler working fluid flows back to the NTGP where it is heated again at the primary heat exchanger. Thus, the working fluid flows through a loop that passes while hot, from the NTGP through an outlet manifold to the secondary system and returns, much cooler, through an inlet manifold to close the loop.

So that the secondary system can be independently designed and built to use the heat from the working fluid, the outlet and inlet manifolds of the distal loop on the NTGP are built to exhibit a pre-determined, or standardized, structure. Thus where the manifolds terminate at outlet and inlet ports, they provide a connection mechanism to which the secondary system may be attached. Since the secondary system may be designed, built, licensed, and managed independently of the NTGP, an NTGP can be licensed and built at lesser expense than what is required to build a traditional nuclear power plant. Since diverse secondary structures other than just power conversion systems for electricity can be coupled to the NTGP, the NTGP is not subject so strictly to the variable load characteristic of electricity markets. Since the NTGP is not so constrained by the variable load of consumer electricity markets and can be built for less expense, the NTGP may be brought to market more readily and operated to satisfy people's voracious appetite for power. Since nuclear power is far cleaner and more carbon neutral than hydrocarbon fossil fuels, systems, components, and methods described herein will minimize global health hazards and diminished quality of life associated with pollution and carbon output.

In certain aspects, a system for providing energy is described. The system includes a reactor core in fluid communication with a primary heat exchanger via a primary fluid loop. The primary heat exchanger is coupled to working fluid loop. The heat exchanger transfers heat from a primary fluid to a working fluid in the working fluid loop. The working fluid loop then carries the heated working fluid to an output manifold. The system includes the output manifold at a first end of the working fluid loop, terminating at an outlet port, as well as an input manifold at a second end of the working fluid loop, terminating at an inlet port. The ports comprise a standardized connection mechanism configured to be coupled to a secondary system that includes a distal fluid loop. When the secondary system is coupled to the connection mechanism, the working fluid loop extends through the secondary system. When the secondary system is coupled to the connection mechanism, a working fluid (e.g., a molten salt composed of any combination of AlCl₃, NaCl, CaCl₂, ZrCl₄, ZnCl₂, FeCl₂, and/or KCl) flows through the working fluid loop and transfers heat that originate at the reactor core to the secondary system. Any suitable secondary system may be connected such as a power conversion system, a desalination system, or a heating system.

The connection mechanism may include a first apparatus comprising a first material on the outlet port and a second apparatus comprising a second material on the inlet port. The first and second materials may be the same or different as may be the first and second apparatuses. In some embodiments, the connection mechanism includes a flange mating joint at either or both outlet port.

The system may optionally include a startup subsystem. The startup subsystem includes a pump, reservoir, cooler and heater to introduce a heated working fluid into the working fluid loop or to cool the working fluid in the loop for removal of decay heat. Valves and shunts are included to sequester the working fluid until introduction into the primary heat exchanger. The startup subsystem may also maintain an inert atmosphere in the output manifold, input manifold, or both when the manifolds are void of a working fluid. The inert atmosphere may consist essentially of an inert gas such as nitrogen, helium or argon. The system may include a salt purification system that removes impurities from the working fluid. Preferably, the fluid loop further comprises a fail-safe system that evacuates the output manifold in the event of an overpressure event or failure of the primary heat exchanger or energy conversion system heat exchangers.

In preferred embodiments, the system is a molten salt reactor, and the reactor core includes molten salt as a nuclear fuel. The molten salt may be a chloride salt and the reactor core preferably operates in the fast spectrum.

In certain aspects, a method of providing power is described. The method includes providing a NTGP that includes a reactor core in fluid communication with a primary heat exchanger via a primary fluid loop, a working fluid loop through the heat exchanger and in thermal communication with the primary fluid loop within the heat exchanger, and output and input manifolds on the ends of the fluid loop. The output and input manifolds terminate at outlet and inlet ports, respectively. A secondary system is connected to a standardized connection mechanism on the outlet port and the inlet port, the connection mechanism configured to be coupled to a secondary system. By connecting the secondary system, the working fluid loop is extended into the secondary system. The working fluid loop then provides thermal energy to the secondary system.

### BRIEF DESCRIPTION OF THE DRAWINGS

FIG. 1 shows a nuclear thermal generator (“NTG”) system for providing energy.

FIG. 2 shows a start-up system of a universal thermal interconnect.

FIG. 3 gives a detail view of a primary fluid loop and a fluid loop.

FIG. 4 diagrams a method of providing power.

FIG. 5 is a schematic diagram of a molten salt reactor system.

FIG. 6 shows additional detail of the chemical processing plant.

FIG. 7 gives a block diagram showing components of an NTGP system.

FIG. 8 is a block diagram showing exemplary secondary systems.

FIG. 9 diagrams operation of a safety system.

FIG. 10 diagrams a response to a leak in a primary heat exchanger.

### DETAILED DESCRIPTION

This disclosure encompasses the apparatus and use of a standardized interface between a nuclear thermal generating plant (NTGP) and one or more power conversion systems (PCS). Using systems and methods described herein, design, licensing, and construction of the NTGP are uncoupled from the PCS and thus a nuclear power plant may be considered the NTGP only provided a sufficiently isolating interconnection. The systems and methods provide a standardized thermal connection by which a power system connects to a nuclear reactor. The connection is standardized so that the nuclear reactor may be designed independently of the power system. Systems described herein include a reactor core in fluid communication with a heat exchanger. A fluid loop passes through the heat exchanger. The system includes an output and inlet manifolds at the ends of the fluid loop, terminating in ports that include a standardized connection mechanism. When the secondary system is coupled to the connection mechanism, the working fluid loop extends through the secondary system, and a working fluid can flow through the secondary system via the working fluid loop and transfer heat from the reactor core to the secondary system.

This disclosure defines the components of an interfacing system and the implementation of that system that allows for the independent design of NTGP and PCS. The system comprises the pipe manifold, valve system, pumps, pre-heating and startup system, thermal fluid reservoir, and purification system, and safety systems that transfer heat from the NTGP to one or more PCS. The interface is designed for a specific range of fluid temperatures and flow rates that are readily adaptable to the heat capacities required by a number of applications.

A NTGP interfaces with a working fluid loop through the primary heat exchanger. In some embodiments, the system transfers heat from a chloride molten salt reactor's fuel salt to a thermal transfer chloride salt. A suitable thermal transfer chloride salt or “working fluid” would be 50AlCl3-35NaCl-15KCl. This thermal salt is conveyed by the interconnection system to one or more PCS or another secondary system. The secondary systems are connected with a mechanism such as a flange mating joint at the point of standard connection. The interconnection system provides for the valves, heat exchangers and pumps to move and redirect the flow as needed during transitions in plant function.

The interconnection includes supporting systems that ensure safe and effective operation. A pre-heating and startup system maintains an inert atmosphere (nitrogen, helium or argon) in the interconnection manifold and also monitors and maintains the salt at a sufficient temperature to remain in the liquid phase. A salt reservoir and fail-safe isolation and drainage system will evacuate the manifold on an overpressure event or upon failure of the primary heat exchanger or power conversion system heat exchangers. Additionally, a salt purification system may be included to continuously filter out any corrosion products and transmuted elements that form in the working fluid loop due to irradiation from the fuel salt.

The secondary systems will have standardized connection hardware that share similar thermal inputs, and may also share similar cooling systems or divert some portion of their waste heat to ancillary purposes such as desalination.

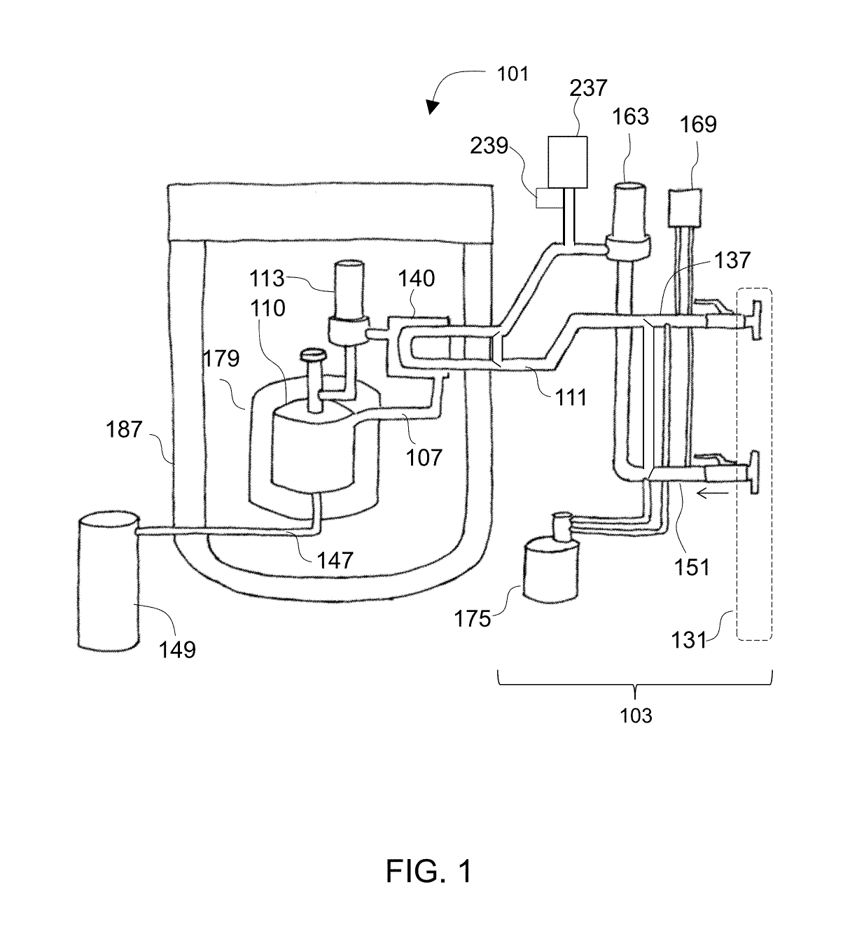

FIG. 1 shows a nuclear thermal generator plant (NTGP) system 101 for providing energy. The NTGP system 101 includes a molten salt reactor core 110 in fluid communication with a primary heat exchanger 140 via a primary fluid loop 107. They system includes components that provide a universal thermal interconnect (UTI) 103. The UTI 103 allows thermal energy from the molten salt reactor core 110 to be provided to other secondary systems in a flexible manner.

In some embodiments, the reactor core includes a molten salt. In certain embodiments, the molten salt is a chloride salt, and the molten salt reactor core 110 operates in the fast spectrum. A working fluid loop 111 extends through the primary heat exchanger 140. The working fluid loop 111 is in thermal communication with the primary fluid loop 107. An output manifold 137 sits at a first end of the working fluid loop 111 and terminates at an outlet port.

An input manifold 151 sits at a second end of the working fluid loop 111 and terminates at an inlet port. A standardized connection mechanism 131 is included on the outlet port and the inlet port. The standardized connection mechanism 131 is configured to be coupled to a secondary system. The standardized connection mechanism 131 may include the same hardware at the outlet port and the inlet port, or it may include different hardware at each port (e.g., because the outlet port delivers salt at a much higher temperature than that of the salt flowing into the inlet port.)

Any suitable secondary system may be coupled to the connection mechanism, and the secondary system preferably includes a distal cooling passage such that when the secondary system is coupled to the connection mechanism, the fluid loop and the distal fluid loop define a distal loop of the heat exchanger.

System 101 preferably also includes a thermal shield 179 surrounding the molten salt reactor core 110. The molten salt reactor core 110 and the primary heat exchanger 140 may be housed in a containment vessel 187, which may be, for example, a concrete and capped structure built into the ground or heavily reinforced. A drain tank 149 is preferably connected to the molten salt reactor core 110 through a freeze plug 147.

The Universal Thermal Interconnect (UTI) 103 is preferably configured to operate as a closed system containing a working fluid that can circulate between the NTGP system 101 and a secondary system (e.g., an energy conversion system). The working fluid for the UTI 103 is chosen to fit the design requirements of the heat exchangers in the NTGP 101 and the secondary system in terms of temperature, operating pressure, and other parameters. A start-up system is provided for operating the UTI 103. The start-up system preferably includes one or more of a working fluid reservoir 237, a pump 163, heating system 239, valves, and shunts. This system may also contain a cooler for removing reactor decay heat during shutdowns.

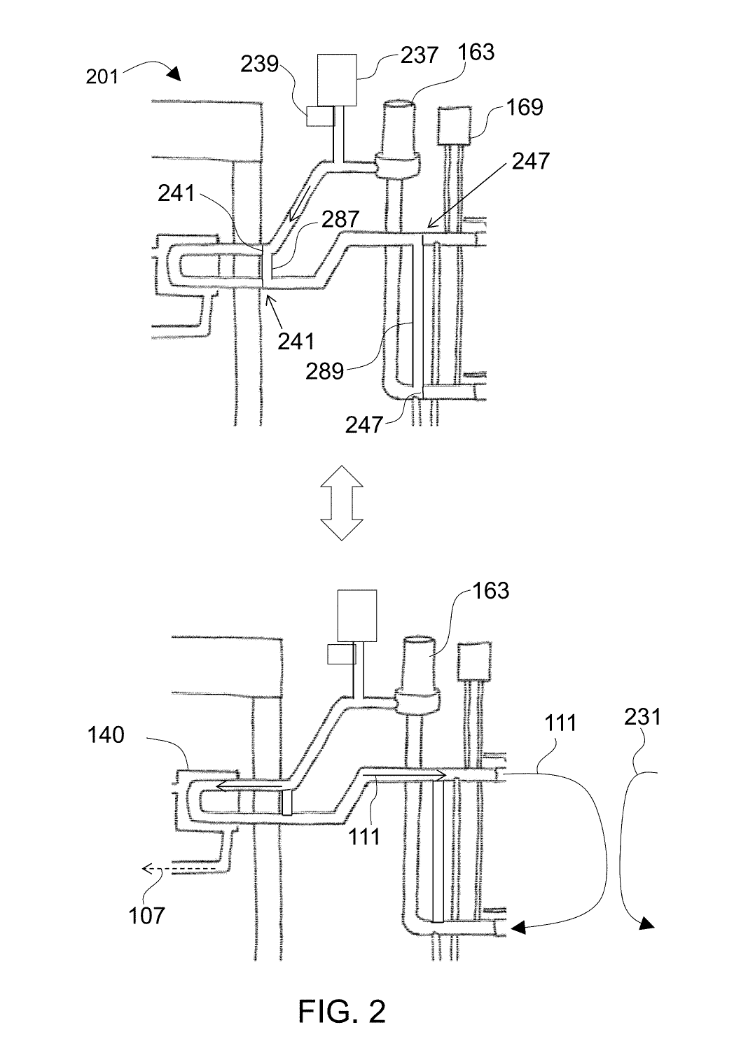

FIG. 2 shows a detail view of a start-up subsystem 201 of the UTI 103 according to certain embodiments. Initially, when a secondary system is not connected to the NTGP system 101, reactor-side isolation valves 241 and connection-side isolation valves 247 will be in first positions that send the working fluid through shunt 287 and shunt 289. The working fluid reservoir 237 contains working fluid that is available to supply the UTI 103. The heating system 239 is provided to heat the working fluid to an appropriate viscosity or to liquefy a salt. A pump 163 drives the working fluid through the pipes and shunts. A controller 169 can provide an inert gas (e.g., argon or a noble gas) to pipes that are on a distal side of the connection-side isolation valves 247. When the NTGP system 101 is connected to a secondary system and the entire system goes into operation, the start-up subsystem 201 operates to open the reactor-side isolation valves 241 and the connection-side isolation valves 247, switching the UTI 103 into the configuration shown in the bottom of FIG. 2. This defines a working fluid loop 111 that allows thermal energy to be transferred from the NTGP to the secondary system.

The primary fluid loop 107 lies within the NTGP. The nuclear fuel (e.g., molten salt) circulates within the primary fluid loop 107 between the molten salt reactor core 110 and the primary heat exchanger 140. The working fluid loop 111 passes the working fluid from the primary heat exchanger 140 to the secondary system. Within the secondary system, a distal fluid loop 231 takes up thermal energy from the working fluid.

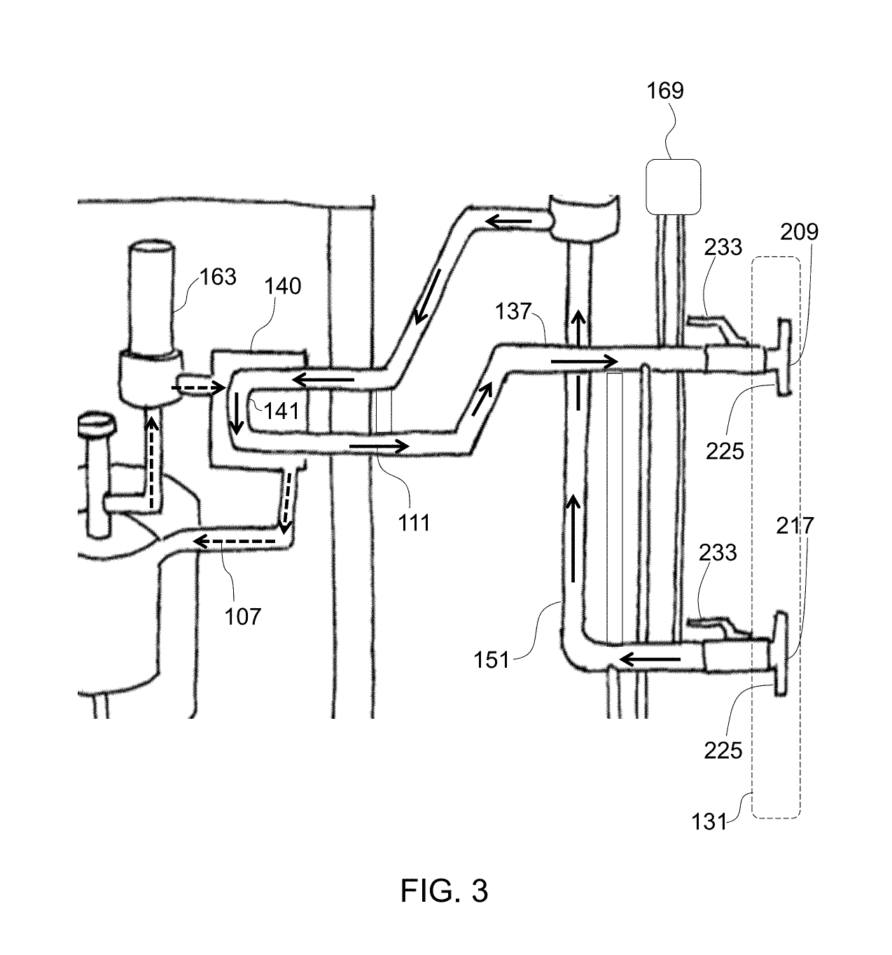

The working fluid crosses the boundary of the UTI 103 at the inlet and outlet ports located on the NGTP side (hot) and the secondary system side (cold), all via the working fluid loop 111. The ports on the secondary system side are shown in greater detail in FIG. 3 The working fluid leaves the NGTP outlet and returns from the NGTP heated from the primary heat exchanger 140. The working fluid then flows through the working fluid loop 111 out of the UTI 103 from the outlet port on the secondary system side (see FIG. 3) and returns from a secondary heater exchanger or a distal passage in the secondary system. The cold working fluid then flows back into the UTI 103 via the inlet port and then back to the NGTP-side outlet.

The UTI working fluid is circulated via a pumping system (e.g., using pump 163), and is kept molten initially by the heating system 239. The flow in the UTI 103 circulates within the boundaries of the UTI 103 via the shunts 287, 289 located near the inlet and outlet ports on the NGTP and PCS sides, respectively. When the system is started up, these shunts will be closed off, and the working fluid will fill the heat exchangers in the secondary system and the NGTP. The excess volume of fluid needed to fill the heat exchangers is stored in reservoir 137 of the UTI 103. The working fluid reservoir 237 also serves as volume expansion tanks to absorb natural volume changes to the working fluid as a result of temperature change.

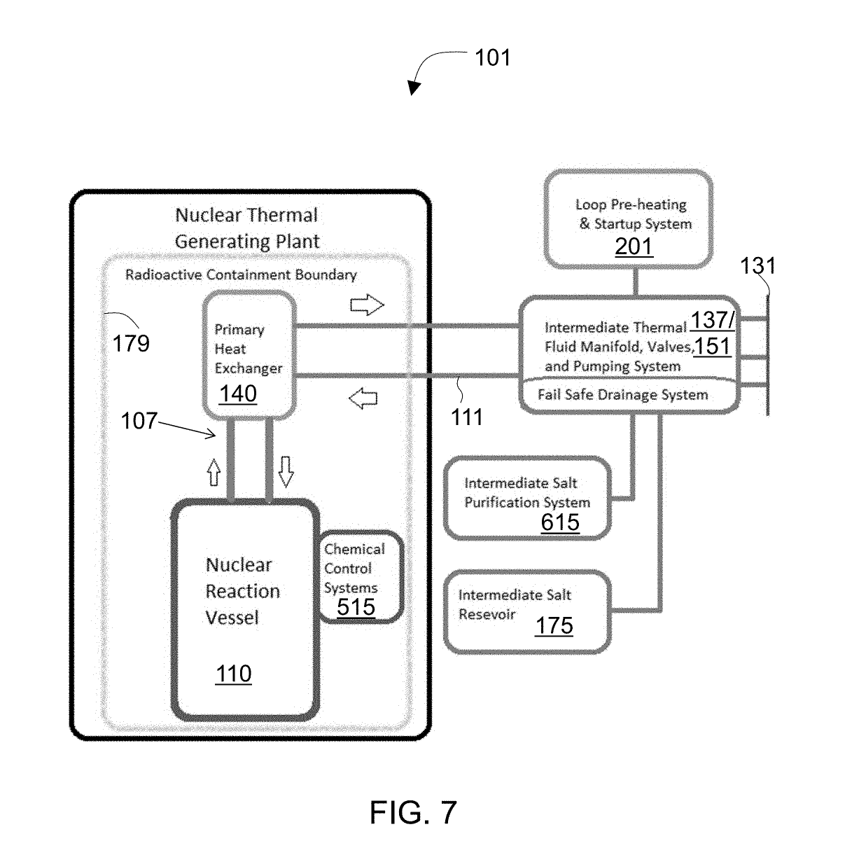

The port sizes on the UTI 103 are standardized, allowing a wide variety of secondary systems to be connected. The UTI 103 pump flow rate will be set to provide proper temperature changes across the heat exchangers. Preferably, the UTI 103 has a working fluid purification system 615 (see FIG. 7) and a salt reservoir tank 175 (e.g., a failsafe drainage tank).

FIG. 3 gives a detail view of the primary fluid loop 107 and the working fluid loop 111. Dashed arrows indicate the flow direction of a fuel such as a molten salt 130, preferably a chloride salt supporting a fast-spectrum reaction in the molten salt reactor core 110. The solid arrows indicate the flow direction of a working fluid. A nuclear reaction in the molten salt reactor core 110 may heat the molten salt 130 to very high temperature. The molten salt 130 is hot and flows via a pump 163 into the primary heat exchanger 140. Within the primary heat exchanger 140, the primary fluid loop 107 is in thermal communication with the working fluid loop 111. The working fluid loop 111 includes the output manifold 137 and the input manifold 151. The output manifold 137 terminates at an outlet port 209. The input manifold 151 at a second end of the working fluid loop 111 terminates at an inlet port 217. A standardized connection mechanism 131 is disposed at the ports for connection to a secondary system that provides a distal fluid loop.

In some embodiments, the standardized connection mechanism 131 includes a first apparatus of a first material on the outlet port and a second apparatus of a second material on the inlet port. The first material and the second material may be the same or different.

The standardized connection mechanism 131 may include any suitable apparatus or mechanism at either or both of the outlet port and the inlet port. For example, the mechanism may include a receiver tube that sleeves over a corresponding pipe on the secondary system (or a pipe dimensioned to be slid into a receiver tube on the secondary system. In certain embodiments, the standardized connection mechanism 131 includes a flange mating joint 225.

The NTGP system 101 may include a startup subsystem 201 that includes controller 169 that maintains an inert atmosphere in the output manifold 137, input manifold 151, or both when the manifolds are void of a working fluid. The inert atmosphere may consist essentially of one selected from the group consisting of nitrogen and argon.

The NTGP system 101 may include one or more valves 233 to seal the working fluid loop 111, e.g., to maintain an inert atmosphere within while the system is not in use for the cycling of a working fluid. The fluid loop may optionally include a fail-safe system and the salt reservoir 175 (see FIG. 1) that evacuates the output manifold in the event of an overpressure event or failure of the primary heat exchanger.

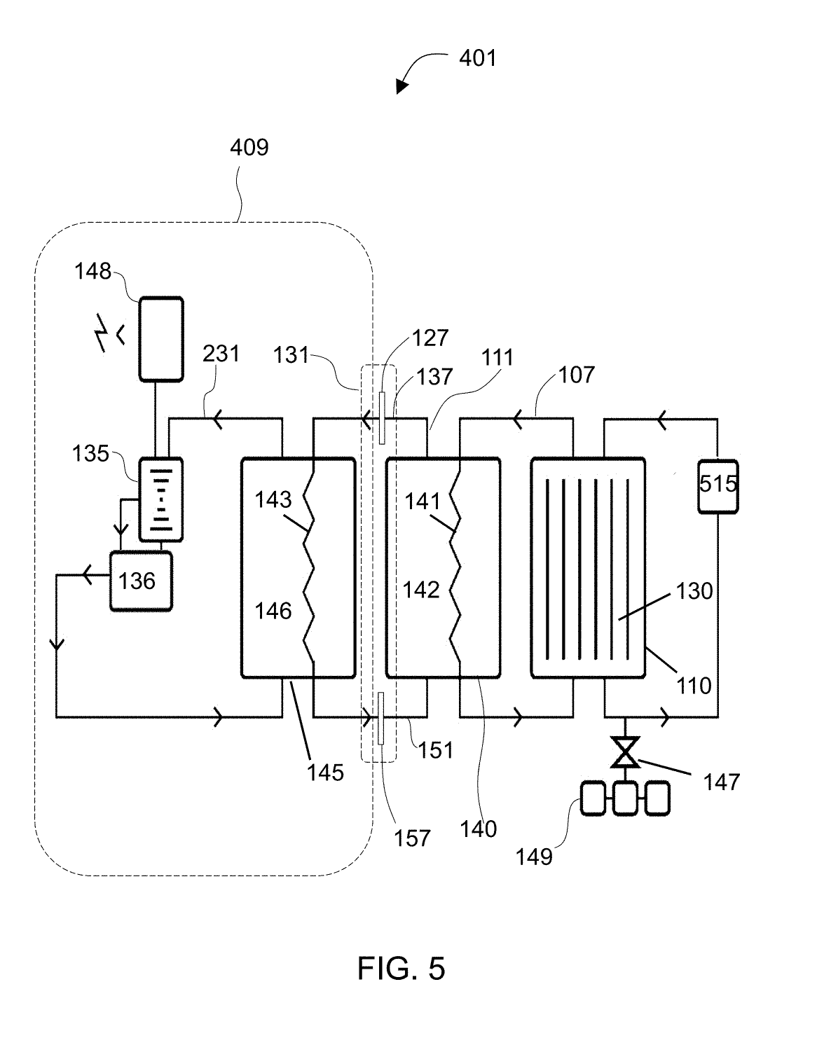

In preferred embodiments, when the secondary system is coupled to the connection mechanism, working fluid flows through the working fluid loop 111 (see FIG. 5) and transfers heat from the reactor core to the secondary system 409. The working fluid may consist of a molten salt composed of any or all of the components AlCl₃, NaCl, CaCl2, ZrCl4, ZnCl2, FeCl2, and/or KCl. Any suitable secondary system may be connected to the NTGP system 101. For example, the secondary system may be a power conversion system, a desalination system, or a heating system.

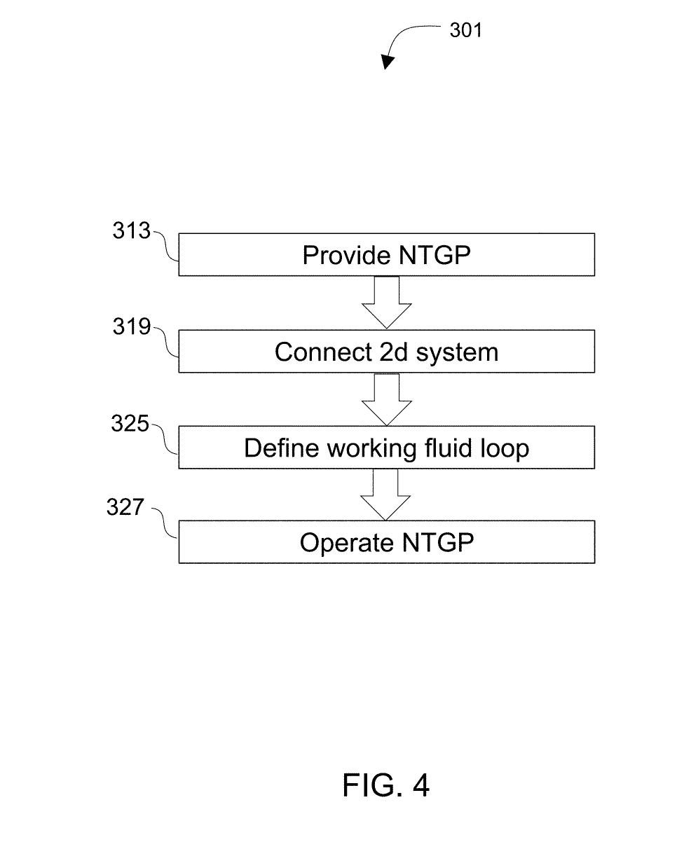

FIG. 4 diagrams a method 301 of providing power. The method 301 includes providing 313 a nuclear thermal generator (NTG) that includes a reactor core in fluid communication with a primary heat exchanger via a primary fluid loop, a fluid loop through the heat exchanger and in thermal communication with the primary fluid loop within the heat exchanger, and output and input manifolds on the ends of the working fluid loop. The output and input manifolds terminate at outlet and inlet ports, respectively. A secondary system that includes a distal fluid loop is connected 319 to a standardized connection mechanism on the outlet port and the inlet port, the connection mechanism configured to be coupled to a secondary system comprising a distal fluid loop. By connecting the secondary system, the distal fluid loop and the working fluid loop 111 combine to define a distal fluid loop. The system 101 can then use the coolant system to operate 327 to provide thermal energy.

FIG. 5 is a schematic diagram of a molten salt reactor system 401 for the generation of electrical energy from nuclear fission. The molten salt reactor system 401 includes a molten salt reactor core 110, containing molten salt 130, which may include a mixture of chloride and fluoride salts. The mixture may comprise fissile materials, including thorium (Th), protactinium (Pa), uranium (U), neptunium (Np), Plutonium (Pu), Americium (Am), Curium (Cm) (more specifically Th-225, Th-227, Th-229, Pa-228, Pa-230, Pa-232, U-231, U-233, U-235, Np-234, Np-236, Np-238, Pu-237, Pu-239, Pu-241, Am-240, Am-242, Am-244, Cm-243, Cm-245, Cm-247), and fertile materials, existing as salts such as Th232Cl4, U238Cl3 and U238Cl4. In this embodiment, the salt mixture comprises fissile materials including U233Cl3, U235Cl3, U233Cl4, U235Cl4, and Pu239Cl3; and carrier salts including sodium chloride (NaCl), potassium chloride (KCl), and/or calcium chloride (CaCl2).

Upon absorbing neutrons, nuclear fission may be initiated and sustained in the molten salt 130 (e.g., fissile molten salt), generating heat that elevates the temperature of the molten salt 130 to, e.g. approximately 650° C. ≈1,200° F. The heated molten salt 130 is transported through a primary fluid loop 107 via a pump (not shown) from the molten salt reactor core 110 to a primary heat exchanger 140, which is configured to transfer the heat of the molten salt 130 to a secondary system 409 through a standardized connection mechanism 131 on the outlet port 127 and the inlet port 157. An output manifold 137 carries the working fluid 142 (e.g., hot working fluid) away from the primary heat exchanger 140 to the secondary system 409. An input manifold 151 returns the working fluid 142 (e.g., working fluid) from the secondary system 409 back to the primary heat exchanger 140. Thus, the depicted system includes a standardized connection mechanism 131 as provided using systems and methods of described herein.

The transfer of heat from the molten salt 130 may be realized in various ways. For example, the primary heat exchanger 140 may include a pipe 141, through which the heated molten salt 130 travels, and a working fluid 142 (e.g., a working fluid) that surrounds the pipe and absorbs heat from the molten salt 130. Upon heat transfer, the temperature of the molten salt 130 is reduced in the primary heat exchanger 140, and the molten salt 130 is transported from the primary heat exchanger 140 back to the molten salt reactor core 110. A secondary heat exchange unit 145 may be included to transfer heat from the working fluid 142 (e.g., working fluid) to a tertiary fluid 146 (e.g., water), as the working fluid 142 (e.g., working fluid) is circulated through secondary heat exchange unit 145 via pipe 143.

The heat received from the molten salt 130 may be used to generate power (e.g., electric power) using any suitable technology. For example, the water in the secondary heat exchange unit 145 is heated to a steam and transported to a turbine 135. The turbine 135 is turned by the steam and drives an electrical generator 148 to produce electricity. Steam from the turbine 135 is conditioned by an ancillary gear 136 (e.g., a compressor, a heat sink, a pre-cooler or a recuperator) and transported back to the secondary heat exchange unit 145.

Alternatively, the heat received from the molten salt 130 may be used in other applications such as nuclear propulsion (e.g., marine propulsion), desalination, domestic or industrial heating, hydrogen production, or a combination thereof.

During the operation of the molten salt reactor core 110, fission products will be generated in the molten salt 130. The fission products will include a range of elements. In this preferred embodiment, the fission products may include, but are not limited to, rubidium (Rb), strontium (Sr), cesium (Cs), barium (Ba), an element selected from lanthanides, palladium (Pd), ruthenium (Ru), silver (Ag), molybdenum (Mo), niobium (Nb), antimony (Sb), technetium (Tc), Xenon (Xe) or Krypton (Kr).

The buildup of fission products (e.g., radioactive noble metals and radioactive noble gasses) in molten salt 130 may impede or interfere with the nuclear fission in the molten salt reactor core 110 by poisoning the nuclear fission. For example, xenon-135 and samarium-149 have a high neutron absorption capacity, and may lower the reactivity of the molten salt. Fission products may also reduce the useful lifetime of the molten salt reactor core 110 by clogging components, such as heat exchangers or piping.

Therefore, it may be preferable to keep concentrations of fission products in the molten salt 130 below certain thresholds to maintain proper functioning of the molten salt reactor core 110. This may be accomplished by a chemical processing plant 515 configured to remove at least a portion of fission products generated in the molten salt 130 during nuclear fission. During operation, molten salt 130 is transported from the molten salt reactor core 110 to the chemical processing plant 515, which may process the molten salt 130 so that the molten salt reactor core 110 functions without loss of efficiency or degradation of components. An actively cooled freeze plug 147 is included and configured to allow the molten salt 130 to flow into the drain tank 149 in the case of power failure or on active command.

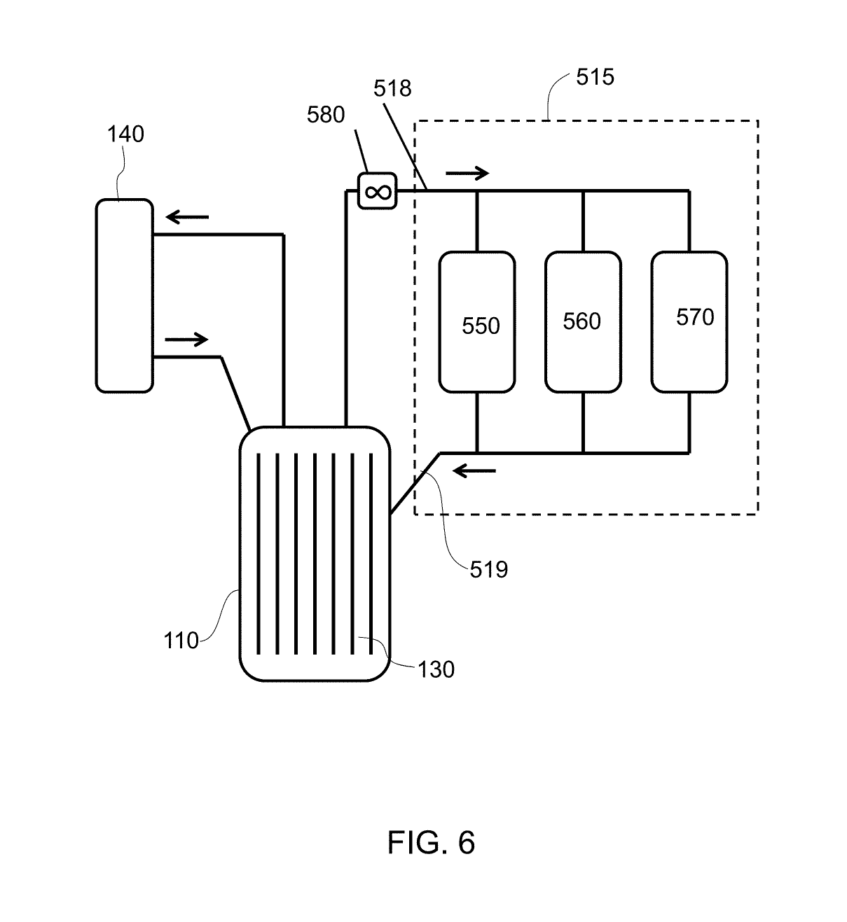

FIG. 6 shows additional detail of the chemical processing plant 515. The molten salt 130 is circulated continuously (or near-continuously) by way of pump 580 from the molten salt reactor core 110 through the chemical processing plant 515 (e.g., over a delivery line 518 and a return line 519). In addition to removing fission products, the chemical processing plant 515 is also configured to limit or reduce the corrosion of the molten salt reactor core 110 by the molten salt 130 by way of a corrosion reduction unit 550.

The chemical processing plant 515 also includes a unit 560 configured to remove at least part of the insoluble fission products (e.g., krypton (Kr), Xenon (Xe), palladium (Pd), ruthenium (Ru), silver (Ag), molybdenum (Mo), niobium (Nb), antimony (Sb), technetium (Tc)) from molten salt 130. The unit 560 is also configured to remove at least part of the dissolved gas fission products (e.g., Xenon (Xe) or Krypton (Kr)).

Also included in chemical processing plant 515 is salt exchange unit 570 that is configured to remove at least a portion of the fission products (e.g., rubidium (Rb), strontium (Sr), cesium (Cs), barium (Ba) or an element selected from lanthanides) soluble in the molten salt 130. The removal of soluble fission products may be realized through various mechanisms.

As indicated above, to limit corrosion of the molten salt reactor core 110, the chemical processing plant 515 includes a corrosion reduction unit 550 configured to protect the corrosion of the molten salt reactor core 110 by the molten salt 130. The molten salt reactor core 110 is typically constructed of metallic alloy including one or more of the following elements: iron (Fe), nickel (Ni), chromium (Cr), manganese (Mn), carbon (C), silicon (Si), niobium (Nb), titanium (Ti), vanadium (V), phosphorus (P), sulfur (S), molybdenum (Mo) or nitrogen (N). The molten salt 130 may include uranium tetrachloride (UCl4) that will corrode the molten salt reactor core 110 by oxidizing chromium (Cr→Cr³⁺+3e−; Cr+3UCl₄→CrCl₃+3UCl₃).

During the nuclear fission, the molten salt 130 is transported from the molten salt reactor core 110 to the corrosion reduction unit 550 and from the corrosion reduction unit 550 back to the molten salt reactor core 110. The transportation of the molten salt 130 may be driven by pump 580 which may be configured to adjust the rate of transportation. The corrosion reduction unit 550 is configured to process the molten salt 130 to maintain an oxidation-reduction (redox) ratio, E(o)/E(r), in the molten salt 130 in the molten salt reactor core 110 (and elsewhere throughout the system) at a substantially constant level, wherein E(o) is an element (E) at a higher oxidation state (o) and E(r) is the element (E) at a lower oxidation state (r).

In a preferred embodiment, the element (E) may be an actinide (e.g., uranium (U)) and E(o) is U(IV) and E(r) is U(III). In this embodiment, U(IV) is in the form of uranium tetrachloride (UCl4), U(III) is in the form of uranium trichloride (UCl₃), and the redox ratio is a ratio E(o)/E(r) of UCl4/UCl3. Although UCl4 corrodes the molten salt reactor core 110, the existence of UCl4 reduces the melting point of the molten salt 130. Therefore, the level of the redox ratio, UCl4/UCl3, may be selected based on the desired corrosion reduction and the desired melting point of the molten salt 130. For example, the redox ratio may be at a substantially constant ratio selected between 1/50 and 1/2000. More specifically, the redox ratio may be at a substantially constant level of 1/2000.

The following are more comprehensive listings of fission products applicable to the systems and methods described herein. These lists are illustrative and not meant to be exhaustive.

Fission products sufficiently noble to maintain a reduced and insoluble state in molten salt can include:

Germanium-72, 73, 74, 76

Arsenic-75

Selenium-77, 78, 79, 80, 82

Yttrium-89

Zirconium-90 to 96

Niobium-95

Molybdenum-95, 97, 98, 100

Technetium-99

Ruthenium-101 to 106

Rhodium-103

Palladium-105 to 110

Silver-109

Cadmium-111 to 116

Indium-115

Tin-117 to 126

Antimony-121, 123, 124, 125

Tellurium-125 to 132

Fission products that will form gaseous products at the operating temperatures can include:

Bromine-81

Iodine-127, 129, 131

Xenon-131 to 136

Krypton-83, 84, 85, 86

Fission products that will remain in the salt as chloride compounds in addition to Actinide chlorides (Th, Pa, U, Np, Pu, Am, Cm) and carrier salt chlorides(Na, K, Ca) can include:

Rubidium-85, 87

Strontium-88, 89, 90

Cesium-133, 134, 135, 137

Barium-138, 139, 140

Lanthanides (lanthanum-139, cerium-140 to 144, praseodymium-141, 143, neodymium-142 to 146, 148, 150, promethium-147, samarium-149, 151, 152, 154, europium-153, 154, 155, 156, Gadolinium-155 to 160, Terbium-159, 161, and Dysprosium-161)

FIG. 7 gives a block diagram showing components of the NTGP system 101. Within the thermal shield 179 are the molten salt reactor core 110 coupled to the primary heat exchanger 140 via the primary fluid loop 107. The working fluid loop 111 transfers working fluid from the primary heat exchanger 140 to the manifolds 137 and 151. The NTGP system 101 preferably includes the startup subsystem 201, at least one salt reservoir 175, and the working fluid purification system 615 (e.g., an intermediate salt purification system). The system provides a point of standard connection in the form of the standardized connection mechanism 131. The standardized connection mechanism 131 is standardized meaning that it is built as described in a documented standard. The standard is documented in that it is written or diagrammed and can be accessed and understood by the human mind and also that multiple people have agreed to accept it as a standard for the connection of hardware that allows the passage of molten salt for the purpose of transferring energy. That is, standardized means something other than “built using common nuts and bolts that are themselves standard fare found in hardware stores.” Standardized includes those things recognized by standards institutes such as the American National Standards Institute or similar. Standardized may mean to be designed, built, or provided according to an established norm that establishes uniform engineering or technical criteria.

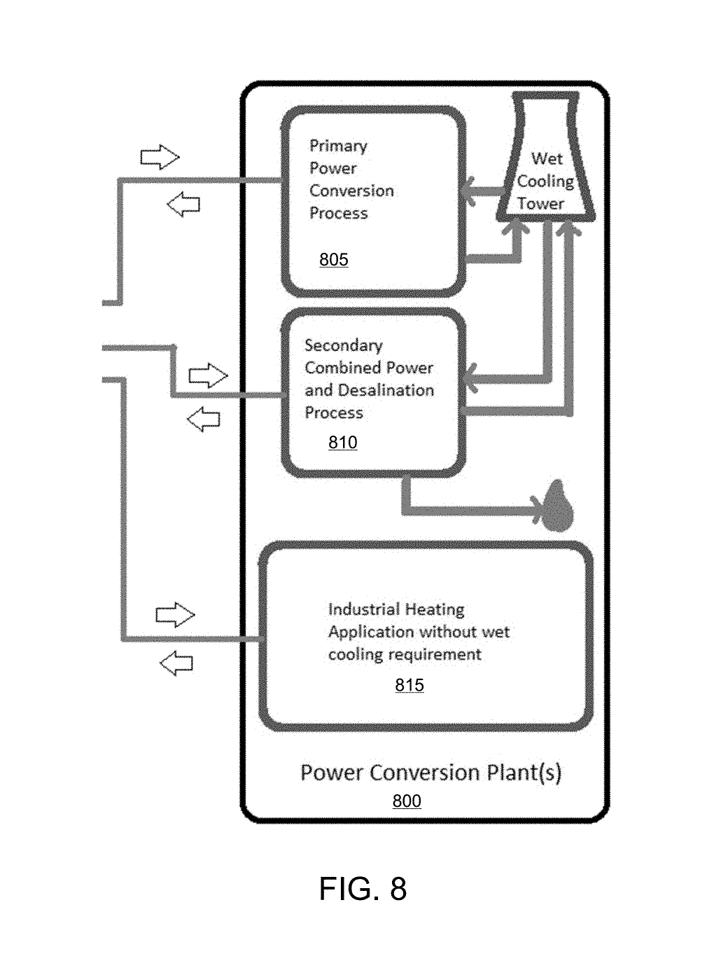

FIG. 8 is a block diagram showing exemplary secondary systems 800 that may be connected to standardized connection mechanism. Exemplary secondary systems 800 include a primary power conversion system 805, a desalination system 810, and an industrial heating system 815.

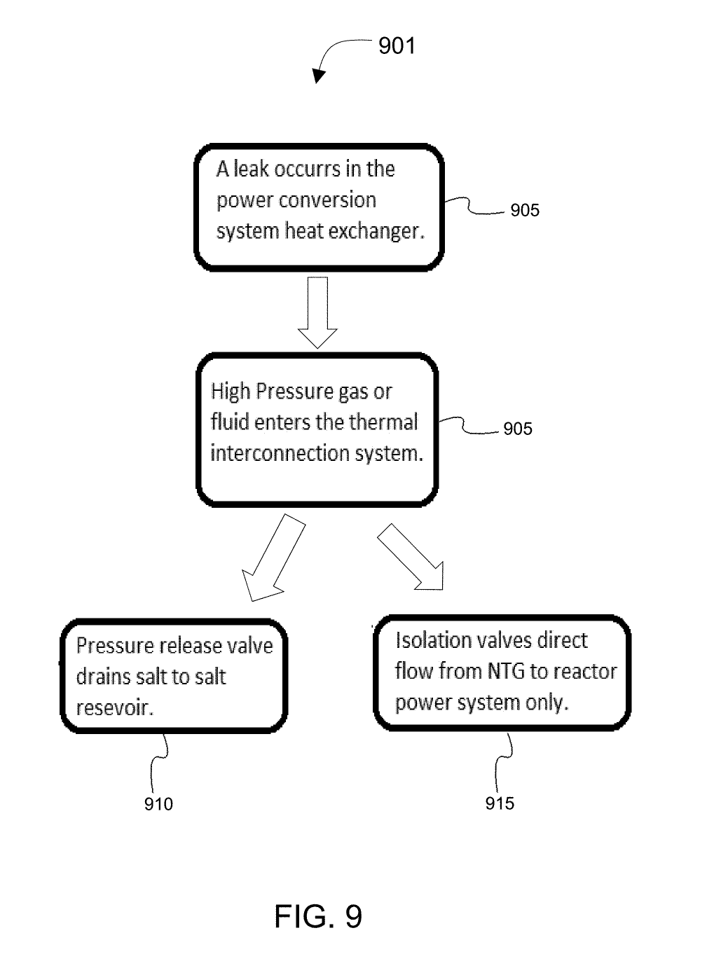

FIG. 9 diagrams a method 901 of operation of a safety system. In the event that a leak occurs, at 905, within a heat exchanger within a secondary subsystem such as a power conversion system (PCS), the UTI 103 operates for safety. A high pressure gas or fluid, at 910, will enter the UTI 103, triggering a safety response. At 910, a pressure release valve will open to drain the working fluid (e.g., a molten salt) to the salt reservoir 175. Additionally, the reactor-side isolation valves 241 can be, at 915, operated to direct flow of the working fluid away from the NTGS. The UTI 103 preferably also has safety system for responding to a leak in the primary heat exchanger 140.

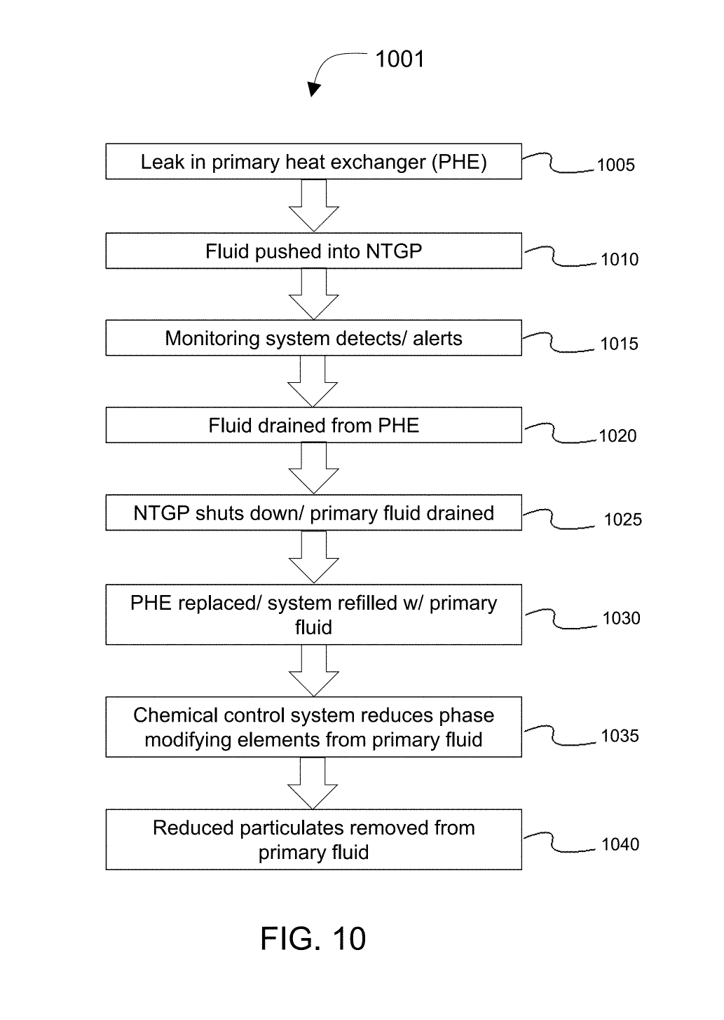

FIG. 10 diagrams a method 1001 for a response to a leak in a primary heat exchanger 140. When a leak occurs, at 1005, in the primary heat exchanger of the NTGS, slightly higher pressure drives, at 1010, significantly chemically compatible fluid into the primary fluid loop 107 at a low rate. At 1015, the chemical processing plant 515 detects the leak and alerts the UTI 103. In response, at 1025, the NTGS is shut down and the system drains, at 1020, the primary reactor fluid (e.g., the molten salt nuclear fuel) from the primary heat exchanger 140. The UTI 103 drains and isolates the working fluid from the primary heat exchanger 140 (e.g., draining into reservoir 175 and isolation via reactor-side isolation valves 241). This allows the primary heat exchanger 140 to be replaced. The system is refilled (e.g., with slightly contaminated primary reactor fluid). At 1035, the chemical processing plant 515 operates to reduce additionally phase modifying elements from the primary fluid. The unit 560 operates, at 1040, as a particulate filtration system to remove reduced particulates from the primary fluid.

References to other documents, such as patents, patent publications, and articles, are made in this disclosure. All such documents are incorporated by reference.

Various modifications of the systems and methods and many further embodiments thereof, in addition to those shown and described herein, will become apparent to those skilled in the art from the full contents of this document, including references to the scientific and patent literature cited herein. The disclosure herein contains information, exemplification, and guidance that can be adapted to the practice of the concepts described herein in their various embodiments and equivalents thereof.

What is claimed is:

1. A system for providing thermal energy, the system comprising:
a thermal source in fluid communication with a primary heat exchanger via a primary fluid loop;
a working fluid loop through the primary heat exchanger, the working fluid loop in thermal communication with the primary fluid loop;
an output manifold at a first end of the working fluid loop, the output manifold terminating at an outlet port;
an input manifold at a second end of the working fluid loop, the input manifold terminating at an inlet port; and
a standardized connection mechanism on the outlet port and the inlet port, the standardized connection mechanism configured to be coupled to a secondary system,
wherein when the secondary system is coupled to the standardized connection mechanism, the working fluid loop extends through the secondary system.

2. The system of claim 1, wherein the standardized connection mechanism comprises a first apparatus comprising a first material on the outlet port and a second apparatus comprising a second material on the inlet port.

3. The system of claim 2, wherein the first material and the second material are different.

4. The system of claim 1, wherein the standardized connection mechanism comprises a mating joint.

5. The system of claim 4, wherein the mating joint comprises a flange.

6. The system of claim 1, further comprising a startup subsystem that maintains an inert atmosphere in the output manifold when the output manifold is void of a working fluid.

7. The system of claim 6, wherein the inert atmosphere consists essentially of nitrogen or a noble gas.

8. The system of claim 1, wherein when the secondary system is coupled to the standardized connection mechanism, a working fluid transfers heat from the thermal source to the secondary system.

9. The system of claim 8, wherein the working fluid is thermally compatible with operating temperatures of the thermal source and the secondary system.

10. The system of claim 9, wherein the working fluid is chemically compatible with a primary fluid in the thermal source.

11. The system of claim 8, wherein the working fluid consists essentially of a molten salt composed of any combination of or all of the components AlCl₃, NaCl, CaCl₂, ZrCl₄, ZnCl₂, FeCl₂, and/or KCl.

12. The system of claim 8, further comprising a salt purification system that removes impurities from the working fluid.

13. The system of claim 12, wherein the secondary system comprises one selected from the list consisting of: a power conversion system; a desalination system; a cooling system; and a heating system.

14. The system of claim 1, wherein the working fluid loop further comprises a fail-safe system that evacuates the output manifold in the event of an overpressure event or failure of the primary heat exchanger and/or power conversion system heat exchanger.

15. The system of claim 1, wherein the reactor source comprises a molten salt.

16. The system of claim 15, wherein the molten salt comprises a chloride salt, and the thermal source operates in the fast spectrum.

17. The system of claim 1, further comprising a startup subsystem operable to fill the working fluid loop with a working fluid.

18. The system of claim 17, wherein the startup subsystem includes a heater and a pump.

19. The system of claim 1, wherein the output manifold has a diameter configured to provide a predetermined amount of a thermal energy when a working fluid flows a predetermined mass flow.

20. The system of claim 1, wherein the thermal source comprises a reactor core.
